(19) United States
(12) Patent Application Publication
(10) Pub. No.: US 2007/0297830 A1
(43) Pub. Date: Dec. 27, 2007

(54) IMAGE FORMING APPARATUS AND PROCESS CARTRIDGE

(76) Inventor: Akio KOSUGE, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/769,066

(22) Filed: Jun. 27, 2007

(30) Foreign Application Priority Data
Jun. 27, 2006 (JP) 2006-176003

(51) Int. Cl. G03G 21/00

(52) U.S. Cl. 399/128

(57) ABSTRACT

An image forming apparatus include an image bearer, a charger, and a discharger. The image bearer is configured to bear an electrostatic latent image. The charger is configured to charge the image bearer. The discharger is configured to discharge the image bearer with a discharge light. The amount of the discharge light in image formation is different from the amount of the discharge light in post image-forming processing.

### CROSS REFERENCE TO RELATED APPLICATIONS

This application claims priority and contains subject matter related to Japanese Patent Application No. JP 2006-176003 filed on Jun. 27, 2006 in the Japan Patent Office, the entire contents of which are hereby incorporated by reference.

### BACKGROUND OF THE INVENTION

1. Field of the Invention

The present invention relates to an image forming apparatus and a process cartridge included therein.

2. Discussion of the Background

In general, an electronographic image forming apparatus such as a copying machine, a printer, and a facsimile machine may include an image forming mechanism to form a toner image, an image bearer on which the toner image is formed, and a discharger to discharge the image bearer. In one image forming method, the image bearer is uniformly charged and then light is applied to the surface of the image bearer to form an electrostatic latent image thereon. The image is developed with toner and transferred from the image bearer onto an intermediate transfer belt and then onto a sheet of recording medium.

After the image is transferred, the discharger applies a discharge light to the surface of the image bearer to optically remove electric potentials remaining thereon to prevent defective images. However, the image bearer is optically fatigued by receiving the discharge light, which increases the electric potentials on the image bearer.

A method to prevent defective images (e.g., afterimages) by changing the amount of the discharge light has been proposed. In the method, the amount of discharge light may be properly set based on downtime and continuous operation time of an image forming apparatus.

Further, methods to reduce optical fatigue of an image bearer, as well as to prevent defective images, have been proposed. In a method, test electrostatic latent images are formed in half-tone area on an image bearer before an image is formed. Potential difference in the test electrostatic latent images is detected with a potential sensor, and an amount of discharge light is increased when the potential difference is larger than a reference amount in a detection result.

In another method, a discharge light is applied only to an image region for a first sheet, and/or the amount of discharge light is controlled depending on the resistance of a transfer sheet.

In another method, an image forming apparatus includes a discharger using a discharge phenomenon. A discharge condition is adjusted depending on a transfer condition.

### SUMMARY OF THE INVENTION

In view of foregoing, in one exemplary embodiment, an image forming apparatus includes an image bearer, a charger, and a discharger. The image bearer is configured to bear an electrostatic latent image. The charger is configured to charge the image bearer. The discharger is configured to discharge the image bearer with a discharge light. An amount of the discharge light during image formation is different from an amount of the discharge light during post image-forming processing.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a full color copier employing a tandem intermediate transfer method according to an exemplary embodiment;

FIG. 2 illustrates a configuration of a process cartridge included in an image forming apparatus according to an exemplary embodiment;

FIG. 3 is a cross-section diagram of a charging roller according to an exemplary embodiment; and

FIG. 4 is a graph showing a relation between a voltage applied to a discharge lamp and a current flowing in the discharge lamp.

### DETAILED DESCRIPTION OF PREFERRED EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

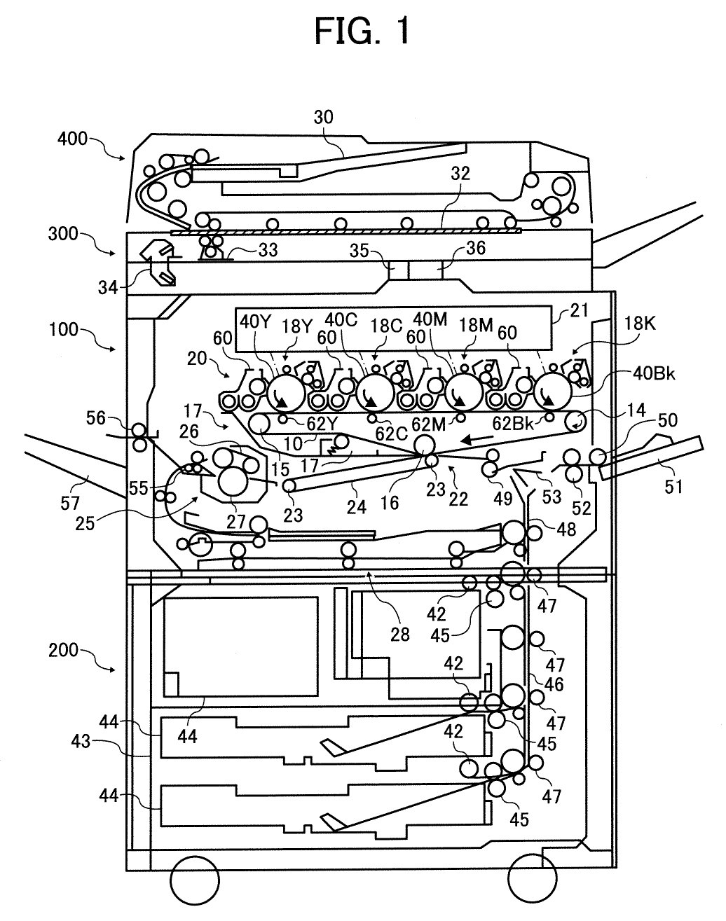

Referring now to the drawings, wherein like reference numerals designate identical or corresponding parts throughout the several views, a tandem type color image forming system according to an exemplary embodiment is described. Referring to FIG. 1, the image forming system includes an image forming apparatus 100, a sheet feeder 200 storing sheets as transfer mediums, a scanner 300 provided over the image forming apparatus 100, and an automatic document feeder (ADF) 400 provided over the scanner 300.

The image forming apparatus 100 includes an intermediate transfer belt 10 as an intermediate transfer member, support rollers 14, 15, and 16, a tandem unit 20, an irradiator 21, and intermediate transfer rollers 62Y, 62C, 62M, and 62Bk. The tandem unit 20 includes image-forming units 18Y, 18C, 18M, and 18K for forming yellow, cyan, magenta, and black images, respectively. The image-forming units 18Y, 18C, 18M, and 18K are process cartridges and are laterally arranged in line along a front surface of the intermediate transfer belt 10. Each of the image-forming units 18Y, 18C, 18M, and 18K includes one of photoreceptors 40Y, 40C, 40M, and 40Bk that are image bearers and one of developing units 60.

The intermediate transfer belt 10 is stretched around the support rollers 14, 15, and 16 and may rotate clockwise in FIG. 1. The support roller 14 is a driving roller for the intermediate transfer belt 10. To manufacture the intermediate transfer belt 10, a resin (e.g. polyvinylidene fluoride, polyimide, polycarbonate, and polyethylene terephthalate) may be molded into a seamless belt. The above resin may be used without adjustment, or used after a resistivity is adjusted with an electroconductive material, for example, carbon black. The intermediate transfer belt 10 may have a layered structure including the above resin as a base and a surface layer formed through a spraying method or a dipping method. With the intermediate transfer belt 10, the photoreceptors 40Y, 40C, 40M, and 40Bk are not directly in contact with a sheet of transfer mediums. Therefore, the potential on each of the photoreceptors 40Y, 40C, 40M, and 40Bk is not affected by the resistivity of the sheet.

The intermediate transfer rollers 62Y, 62C, 62M, and 62Bk, which are primary transferers to transfer the toner images from the photoreceptors 40Y, 40C, 40M, and 40Bk onto the intermediate transfer belt 10, are placed at positions facing one of the photoreceptors 40Y, 40C, 40M, and 40Bk via the intermediate transfer belt 10.

The irradiator 21 may be provided over the tandem unit 20, and includes four laser diodes (LDs) as light sources for respective colors, a polygon scanner, f-theta (f-θ) lenses, long WTL lenses, and mirrors. The polygon scanner includes a six-surface polygon mirror and a polygon motor. The f-theta lenses are placed in light paths of respective light sources. The irradiator 21 sends light from the LDs based on image information of respective colors. The light is reflected by the polygon scanner and sent to the surfaces of the photoreceptors 40Y, 40C, 40M, and 40Bk.

The image forming apparatus 100 may further include a cleaner 17, a secondary transferer 22, a fixer 25, a transport path 48, a pair of registration rollers 49, a feeding roller 50, a manual feed tray 51, a pair of separation rollers 52, a manual feed path 53, a switching claw 55, a pair of ejection rollers 56, and an ejection tray 57.

The cleaner 17 is provided downstream of the support roller 16 in a transport direction of sheet, and removes the toner remaining on the intermediate transfer belt 10 after an image is transferred therefrom onto a sheet.

The secondary transferer 22 is provided beneath the intermediate transfer belt 10. In an exemplary embodiment, the secondary transferer 22 includes a pair of rollers 23 and a secondary transfer belt 24 that is an endless belt. The secondary transfer belt 24 is stretched around the pair of rollers 23. The secondary transfer belt 24 is pressed to the support roller 16 via the intermediate transfer belt 10 and forms a secondary transfer nip with the intermediate transfer belt 10. The image on the intermediate transfer belt 10 is transferred onto the sheet at the secondary transfer nip. The secondary transfer belt 24 may include a material similar to the material of the intermediate transfer belt 10.

The secondary transferer 22 includes a function to transport the sheet to the fixer 25 after the image is transferred thereon. Alternatively, the secondary transferer 22 may be a transfer roller or a transfer charger. In this case, another component to transport the sheet is required.

The fixer 25 is provided at a side of the secondary transferer 22, and fixes the image on the sheet. The fixer 25 includes a fixing belt 26 that is an endless belt and a pressure roller 27. The pressure roller 27 presses against the fixing belt 26. The manual feed tray 51 is attached to a side of the image forming apparatus 100.

The image forming apparatus 100 may further include a reverser 28 and a control panel (not shown). The reverser 28 is provided beneath the secondary transferer 22 and the fixer 25, in parallel with the tandem unit 20, and reverses the sheet to eject the sheet upside down or to form images on both sides of the sheet.

The sheet feeder 200 includes a plurality of feeding rollers 42, a paper bank 43, a plurality of separation rollers 45, a sheet feeding path 46, and a plurality of conveyance rollers 47. The paper bank 43 includes a plurality of sheet cassettes 44. The sheet feeder 200 may send a sheet of transfer mediums to the image forming apparatus 100.

The scanner 300 may include a contact glass 32, a first carriage 33, a second carriage 34, an imaging lens 35, and a reading sensor 36. The first carriage 33 includes a light source. The second carriage 34 includes a mirror. The ADF 400 includes a document table 30 and may automatically forwards the original document placed on the document table 30 to the contact glass 32.

The scanner 300 may read image information from an original document placed on the contact glass 32 with the reading sensor 36.

Processes to read an original document by the scanner 300 for copying are described. A user places an original document on the document table 30. Alternatively, the user opens the ADF 400 and places the original document on the contact glass 32 of the scanner 300, and closes the ADF 400 to hold the sheet with the ADF 400.

When the user pushes a start button (not shown), the original document on the document table 30 is forwarded onto the contact glass 32. Alternatively, the scanner 300 is immediately driven to read the image information of the original document, when the original document is placed on the contact glass 32.

The scanner 300 starts to run the first carriage 33 and the second carriage 34.

The light source of the first carriage 33 emits light to the original document. The light is reflected by a surface of the original document. The reflected light is sent to the second carriage 34. The mirror in the second carriage 34 further reflects the light to forward the light to the reading sensor 36 through the imaging lens 35. Thus, the reading sensor 36 reads image information on the original document.

The user may select a monochrome mode or a full color mode with the control panel. The image forming apparatus 100 starts an image formation in the selected mode based on the image information read as above.

When the user selects the full color mode, the photoreceptors 40Y, 40C, 40M, and 40Bk start to rotate counterclockwise in FIG. 1, respectively. The surfaces of the photoreceptors 40Y, 40C, 40M, and 40Bk are uniformly charged. The irradiator 21 applies laser light according to the image information of respective colors to the photoreceptors 40Y, 40C, 40M, and 40Bk. With the irradiation, electrostatic latent images are formed on the surfaces of the photoreceptors 40Y, 40C, 40M, and 40Bk.

While the photoreceptors 40Y, 40C, 40M, and 40Bk rotate, the developing units 60 develop the electrostatic latent images with toners of respective colors. The toner images of respective colors are sequentially transferred onto the intermediate transfer belt 10 from the photoreceptors 40Y, 40C, 40M, and 40Bk to form a full color image, along with the move of the intermediate transfer belt 10.

After the image is transferred onto the intermediate transfer belt 10, the potentials are optically removed from the surface of each of the photoreceptors 40Y, 40C, 40M, and 40Bk. Further, the cleaner 17 removes the toner remaining thereon. The above discharge is referred to as discharge during image formation, for example, that is a period in which at least one of the photoreceptors 40Y, 40C, 40M, and 40Bk, a charging roller, the irradiator 21, the developing units 60, the intermediate transfer rollers 62Y, 62C, 62M, and 62Bk, and a discharger is operating.

When the monochrome mode is selected, the support roller 15 moves downward, to release the intermediate transfer belt 10 from the photoreceptors 40Y, 40C, and 40M. Only the photoreceptor 40Bk rotates counterclockwise in FIG. 1, and the surface thereof is uniformly charged. The irradiator 21 applies laser light corresponding to the black image, to form an electrostatic latent image. The developing unit 60 in the image-forming unit 18K develops the electrostatic latent image with the black toner. The black image is transferred onto the intermediate transfer belt 10. In this time, the photoreceptors 40Y, 40C, and 40M and developing units 60 in the image-forming units 18Y, 18C, and 18M are in a stopped state, to prevent wear thereof and toner consumption.

In the meantime, the sheet feeder 200 sends out a sheet to the image forming apparatus 100. One of the feeding rollers 42 selectably rotates to send a sheet from a corresponding sheet cassette 44. A pair of separation rollers 45 corresponding to the feeding roller 42 ensures that the sheets are sent one by one to a transport path 46. The conveyance rollers 47 forward the sheet to a transport path 48 in the image forming apparatus 100. Alternatively, the user may use the manual feed tray 51. The feeding roller 50 rotates to send out a sheet from the manual feed tray 51. The pair of separation rollers 52 separates the sheets to send the sheets one by one to the manual feed path 53.

The sheet is transported along the transport path 48 or the manual feed path 53, until the pair of registration rollers 49 stops the sheet by sandwiching a leading edge of the sheet therebetween. The pair of registration rollers 49 may timely forward the sheet to the secondary transfer nip so that the sheet may be lapped over the full color image or the black image on the intermediate transfer belt 10. While the sheet passes through the secondary transfer nip, the secondary transferer 22 transfers the full color image or the black image onto a front side of the sheet.

The secondary transferer 22 forwards the sheet to the fixer 25 that may fix the image on the sheet with heat and pressure. After the fixing process, the switching claw 55 switches a sheet ejection route, according to the mode designated by the user, either to the pair of ejection rollers 56 or to the reverser 28. The pair of ejection rollers 56 ejects the sheet onto the ejection tray 57. When the sheet is sent to the reverser 28, the sheet is reversed and then sent to the secondary transfer nip, where an image is formed on a back side of the sheet. After that, the ejection roller 56 ejects the sheet onto the ejection tray 57. When images are formed on two or more sheets, the above processes are repeated. The discharge (e.g., discharge during image formation) may be performed during each time period corresponding to an image being transferred from one of the photoreceptors 40Y, 40C, 40M, and 40Bk onto the intermediate transfer belt 10.

After images are formed on the predetermined number of sheets in the image formation, post image-forming processing of the photoreceptors 40Y, 40C, 40M, and 40Bk is performed and then the photoreceptors 40Y, 40C, 40M, and 40Bk are stopped. In the post image-forming processing, the photoreceptors 40Y, 40C, 40M, and 40Bk are rotated for one turn or more, with a charge bias applicator and a transfer bias applicator being turned off. During the rotation, dischargers remove potentials on the surfaces of the photoreceptors 40Y, 40C, 40M, and 40Bk to prevent the photoreceptors 40Y, 40C, 40M, and 40Bk from deteriorating. In the monochrome mode, the image forming apparatus 100 may be configured to perform the post image-forming processing only for the photoreceptor 40Bk.

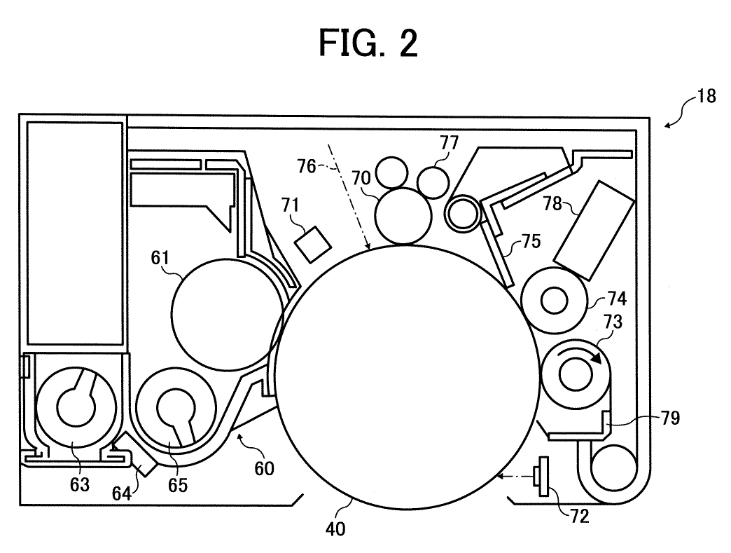

FIG. 2 illustrates one of the image-forming units 18Y, 18C, 18M and 18K.

Because the image-forming units 18Y, 18C, 18M, and 18K have a similar configuration, except for using different color toners, the image-forming unit 18 refers to any one of the image-forming units 18Y, 18C, 18M, and 18K. Likewise, a photoreceptor 40 refers to any one of the photoreceptors 40Y, 40C, 40M, and 40Bk. An intermediate transfer roller 62 refers to any one of the intermediate transfer rollers 62Y, 62C, 62M, and 62Bk. The developing units 60 have a similar configuration, except for using different color toners.

The image-forming unit 18 may further include a charging roller 70, a potential sensor 71, a discharge lamp 72, two brush rollers 73 and 74, a cleaning blade 75, a cleaning roller 77, a lubricant 78, and a toner transport coil 79, around the photoreceptor 40. The components of the image-forming unit 18 are enclosed in a housing having an opening to allow an exposure light 76 from the irradiator 21 to get through.

The developing unit 60 may use a two-component developer including a toner and a carrier. The developing unit may include a developing roller 61, screws 63 and 65, and a toner density 64. The developing roller 61 faces the photoreceptor 40 and includes a rotatable sleeve on the outside and a magnet fixed inside thereof. The screws 63 and 65 agitate and transport the developer. The toner density sensor 64 detects a density of the toner. An amount of toner supplied by a toner supplier (not shown) is determined according to a signal from the toner density sensor 64.

The charging roller 70 uniformly charges the surface of the photoreceptor 40.

The potential sensor 71 detects the potential of the photoreceptor 40. The discharge lamp 72 removes the potential on the surface of the photoreceptor 40. The brush rollers 73 and 74 and the cleaning blade 75 function as a cleaner to remove the toner remaining on the surface of the photoreceptor 40 after the transfer process. The cleaning blade 75 may be formed of polyurethane rubber.

The cleaning roller 77 cleans the surface of the charging roller 70 while being in contact with the charging roller 70 with its weight. The cleaning roller 77 may be a brush roller including a core metal and electroconductive fibers transplanted on the core metal. The cleaning roller 77 is driven to rotate by the rotation of the charging roller 70, and removes stain, dust, etc. (e.g., toner), adhered on the surface of the charging roller 70.

The lubricant 78 may be a solid lubricant being in contact with the brush roller 74, and may function as a lubricant supplier. Examples of the solid lubricant 78 include fatty acid metal salts (e.g., zinc stearate, barium stearate, iron stearate, nickel stearate, cobalt stearate, copper stearate, strontium stearate, calcium stearate, magnesium stearate, zinc oleate, cobalt oleate, magnesium oleate, and palmitic acid zinc salt), natural waxes (e.g., carnauba wax), and fluorinated resins (e.g., polytetrafluoroethylene).

The toner transport coil 79 collects the toner removed from the photoreceptor 40 by the brush rollers 73 and 74 and/or the cleaning blade 75. The toner may be transported to a used toner container (not shown).

In an exemplary embodiment, the image forming apparatus 100 is configured to clean the photoreceptor 40 after discharging the photoreceptor 40. Alternatively, the photoreceptor 40 may be discharged after the photoreceptor 40 is cleaned.

Further, the user may easily replace the image-forming unit 18 because the image-forming unit 18 is configured as a process cartridge that is attachable to and detachable from the image forming apparatus 100. Because the discharge lamp 72 and the photoreceptor 40 are integrated in the process cartridge, the positional relation therebetween may be accurately maintained. Therefore, misalignment of the discharge lamp 72 and the photoreceptor 40 may be prevented, which may prevent shortage of discharge light.

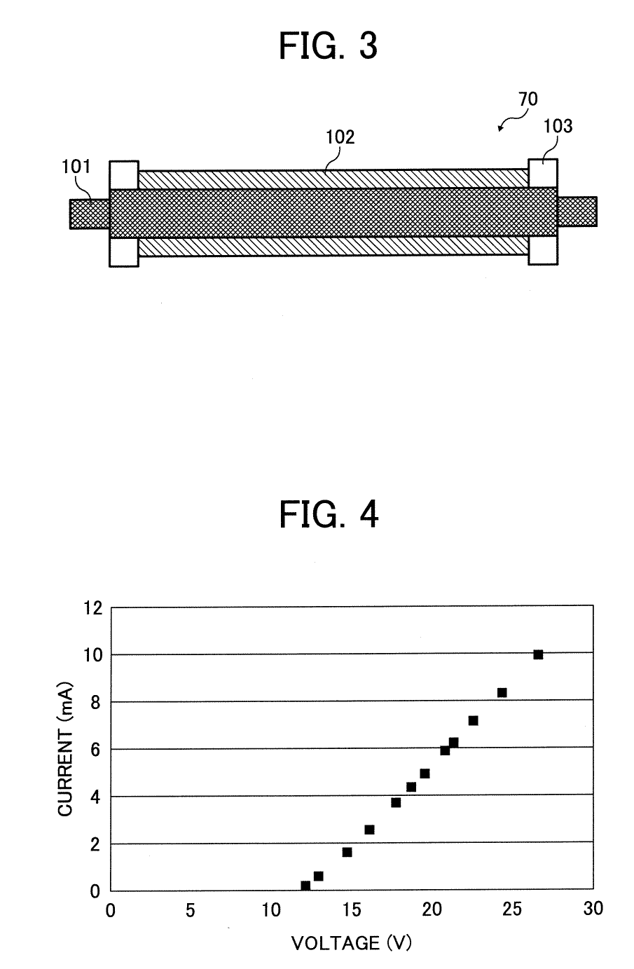

FIG. 3 illustrates a cross-section of the charging roller 70. The charging roller 70 may include a core metal 101 as an electroconductive supporter, a resin layer 102 as a charging member, and a pair of gap holders 103.

The core metal 101 may be a metal such as stainless steel. The core metal 101 may deform when the charging member is cut or when the core metal 101 is pressed by the photoreceptor 40. When the core metal 101 is excessively thin, effect of such deformation increases to a level not to be ignored and accuracy of a charge gap may be impaired. To the contrary, when the core metal 101 is excessively thick, the charging roller 70 increases in size and weight. Therefore, the core metal 101 desirably has a diameter within a range from 6 mm to 10 mm.

The resin layer 102 desirably includes an electroconductive resin having a volume resistivity within a range from 10⁴ Ωcm 10⁹ Ωcm. When the resin layer 102 has an excessively low volume resistivity, a charge bias is likely to leak if the photoreceptor 40 has a defect for example, a pinhole. When the resin layer 102 has an excessively high volume resistivity, an enough discharge phenomenon does not occur and charge potential becomes uneven.

The resin layer 102 may have the desirable volume resistivity by including an electroconductive material in a base resin. Examples of the base resin include polyethylene, polypropylene, polymethyl methacrylate, polystyrene, acrylonitrile-butadiene-styrene co-polymers, and polycarbonates. The above resins have a good molding property and are easily molded.

Because of the above configuration, the charging roller 70 emits less discharge products than a noncontact type charger (e.g., scorotron charger) does. The charging roller 70 has a better potential control than a contact type or an adjacent type charging roller using a DC bias only has.

The electroconductive material is desirably an ionic conductive material, for example, polymers having a quaternary ammonium base. Examples of polyolefin having a quaternary ammonium base include polypropylene, polybutene, polyisoprene, ethylene-ethyl acrylate copolymers, ethylene-methyl acrylate copolymers, ethylene-vinyl acetate copolymers, ethylene-propylene copolymers, and ethylene-hexene copolymers. The conductive material is not limited to the above examples.

The ionic conductive material is uniformly mixed in the base resin by a two-axis kneader, etc. The kneaded material is applied over the core metal 101 through an injection molding method or extrusion molding method. Thus, the kneaded material may be easily shaped in a roller. A desirable blending ratio of the ionic conductive material is within a range from 30 mass parts to 80 mass parts to 100 mass parts of the base resin.

The resin layer 102 desirably has a layer thickness within a range from 0.5 mm to 3 mm. When the resin layer 102 is excessively thin, molding is difficult and strength may be insufficient. When the resin layer 102 is excessively thick, the charging roller 70 increases in size and actual resistivity of the resin layer 102 increases. When the resin layer has an excessively high resistivity, charge efficiency is decreased.

After the resin layer 102 is molded, the pair of gap holders 103, which is preliminary molded, is fixed on both edges of the core metal 101 through a press fit method and/or a bonding method, respectively. Runout phases of the resin layer 102 and the gap holders 103 may be synchronized by cutting and/or grinding the charging roller 70 to adjust the outside diameter thereof after the resin layer 102 and the gap holders 103 are united. Therefore, fluctuation of the gap holders 103 may be reduced.

Examples of the material of the gap holders 103 include insulating resins, for example, polyethylene, polypropylene, polymethyl methacrylate, polystyrene, an acrylonitrile-butadiene-styrene co-polymer, and polycarbonate, similarly to the base resin of the resin layer 102. The gap holders 103 contact a photoconductive layer of the photoreceptor 40. Therefore, the material of the gap holder 103 desirably has a lower hardness degree than the hardness degree of the resin layer 102 to prevent damages to the photoconductive layer. Further, the material may be a resin that excels in a sliding property and is not likely to damage the photoconductive layer may be used for the gap holders 103. Examples of such a resin include polyacetal, an ethylene-ethyl acrylate co-polymer, polyvinylidene fluoride, a tetrafluoroethylene-perfluoroalkyl vinylether co-polymer, and a tetrafluoroethylene-hexafluoropropylene co-polymer.

Further, the resin layer 102 and/or the gap holders 103 may include a surface layer to which the toner hardly adheres, through a coating method, etc. The surface layer may have a thickness about 10 μm.

The pair of gap holder 103 contacts non-image regions of the photoreceptor 40 and forms a gap between the resin layer 102 of the charging roller 70 and the photoreceptor 40. The charging roller 70 may further include gears provided on the edges of the core metal 101. The photoreceptor 40 includes gears provided on flanges thereof. The gears on the edges of the core metal 101 engage with the gears on the flanges of the photoreceptor 40, respectively. The image forming apparatus 100 may further include a motor to drive the photoreceptor 40. When the photoreceptor 40 is driven by the motor and rotates, the charging roller 70 rotates in a similar direction to the rotation direction of the photoreceptor 40. The charging roller 70 rotates at substantially the same linear speed as the speed of the photoreceptor 40. Because the resin layer 102 does not contact the photoreceptor 40, the image region of the photoreceptor 40 is not damaged even if the charging roller 70 is formed with a hard resin and the photoreceptor 40 is an organic photoreceptor. A maximum gap between the resin layer 102 and the photoreceptor 40 is 100 μm or less because an abnormal discharge phenomenon may occur when the gap is excessively large. The abnormal discharge phenomenon prevents uniform charging.

The charging roller 70 forming the gap with the photoreceptor 40 desirably uses a DC voltage overlapped with an AC voltage as a charge bias. With this configuration, the charging roller 70 emits less discharge products than a noncontact charger (e.g., scorotron charger) does. Further, the charging roller 70 has a better potential control than a contact type or an adjacent type charging roller using a DC bias only has.

Next, the toner is described. The toner may include a binder resin, a colorant, and charge controller as main components. The toner may further include additives as required.

Examples of the binder resin include polystyrene, styrene-acrylic ester co-polymers, and polyesters. Materials known as toner colorants may be used as the colorants (e.g., yellow, magenta, cyan, and black) in an exemplary embodiment. The blending ratio of the colorant may be 0.1 mass part to 15 mass parts to 100 mass parts of the binder resin.

Examples of the charge controller include nigrosine dye, chrome containing complexes, and quaternary ammonium salts. One of the above examples may be used depending on a polarity of a toner particle. The blending ratio of the charge controller may be 0.1 mass part to 10 mass parts to 100 mass parts of the binder resin.

It is advantageous to add a fluidity-adding agent to the toner particle. Examples of the fluidity-adding agent include fine particles of metal oxides (e.g., silica, titania, and alumina), fine particles produced by treating the surfaces of one of the above metal oxides with a silane coupling agent or titanate coupling agent, and polymer fine particles (e.g., polystyrene, polymethyl methacrylate, and polyvinylidene fluoride). The fluidity-adding agent has a particle size within a range from 0.01 μm to 3 μm. The blending ratio of the fluidity-adding agent is desirably within a range from 0.1 mass part to 7.0 mass parts to 100 mass parts of the toner particle.

The two-component toner used in an exemplary embodiment may be manufactured through a known method or a combination of known methods. For example, in a kneading and grinding method, a binder resin, a colorant (e.g., carbon black), and a required additive are mixed in a dry condition. The mixture is melted with heat and kneaded by an extruder, a two-roll mill, or a three-roll mill. After being cooled and solidified, the mixture is grinded by a grinder (e.g., jet mill) and classified by a classifier. Thus, the toner is obtained. Alternatively, the toner may be manufactured directly from a monomer, a colorant, and a required additive, through a suspension polymerization method or a non-water dispersion method.

The carrier includes a core particle. Examples of the core particle include ferrate and magnetate. The core particle may have a particle size within a range from 20 μm to 60 μm. The carrier may further include a coating layer covering the core particle.

Examples of a material for the coating layer include vinylidene fluoride, tetrafluoroethylene, hexafluoropropylene, perfluoroalkyl vinyl ether, a vinyl ether produced by substituting a fluorine atom, and a vinyl ketone produced by substituting a fluorine atom. The coating layer may be formed through a known method. For example, a resin is applied on the surface of the core particle through a spraying method or an immersion method.

Next, an example of the photoreceptor 40 is described. The photoreceptor 40 may be a multi-layer organic photoreceptor including an electroconductive supporter and a photoconductive layer from inside thereof. The photoconductive layer includes a charge generating layer and a charge transport layer from inside.

The electroconductive supporter includes a material having a volume resistivity of 10¹⁰ Ωcm or less. The electroconductive supporter may be a cylinder or a film formed of plastic or paper on which a metal or metal oxide layer is formed by evaporation or spattering. Examples of the metal include aluminum, nickel, chrome, nichrome, copper, silver, gold, and platinum. Examples of the metal oxide include tin oxide and indium oxide. Alternatively, the electroconductive supporter may be manufactured by cutting a pipe (e.g., aluminum, aluminum alloy, nickel, stainless steel, etc.) and super-finishing or polishing the surface of the pipe.

The charge generating layer includes a charge generating material as a main component. The charge generating material may be organic or inorganic. Typical charge generating materials are mono azo pigments, disazo pigments, trisazo pigments, perylene pigments, perynone pigments, quinacridone pigments, quinine condensed polyacrylic compounds, squaric acid dyes, phthalocyanine pigments, naphthalocyanine pigments, azulenium salt dyes, selenium, selenium-tellurium alloy, selenium-arsenic alloy, and amorphous silicon. The above materials may be used singly or in combination.

To produce the charge generating layer, the charge generating material is dispersed in a solvent by a ball mill, Atligher, or a sand mill. The binder resin is dispersed in the solvent as required. Examples of the solvent include tetrahydrofuran, cyclohexanone, dioxan, 2-butanone, and dichlorethane. The dispersed liquid is applied on the electroconductive supporter through a immersion method, a spray coating method, or a bead coating method, to form the charge generating layer thereon.

Examples of the binder resin to be used as required include polyamide, polyurethane, polyester, epoxy, polyketone, polycarbonate, silicone, acryl, polyvinyl butyral, polyvinyl formal, polyvinyl ketone, polystyrene, poly acryl, and polyamide. The blending ratio of the binder resin is within a range from 0 weight part to 2 weight parts to 1 weight part of charge generating material.

Alternatively, the charge generating layer may be formed through a known vacuum thin-layer forming method.

The charge generating layer may have a layer thickness within a range from 0.01 μm to 5 μm. A desirable layer thickness is within a range from 0.1 μm to 2 μm.

The charge transport layer includes a charge transport material and a binder resin. The charge transport material and the binder resin are dissolved or dispersed in a solvent.

The solution or dispersion is applied on the charge generating layer and dried. Thus, the charge transport layer is formed. The charge transport layer may include a plasticizer and/or a leveling agent as required.

The charge transport material may be a low-molecule electric charge transporter.

There are two types of low-molecule electric charge transporter: electron transporters and hole transporters. Examples of the electron transporters include electron acceptors, for example, chloranil, bromanil, tetracyanoethylene, tetracyanoquinodimethane, 2,4,7-trinitro-9-fluorenone, 2,4,5,7-tetranitro-9-fluorenone, 2,4,5,7-tetranitro xanthone, 2,4,8-trinitro thioxanthone, 2,6,8-trinitro-4H-indeno[1,2-b]thiophene-4-one, and 1,3,7-trinitro dibenzothiophene5,5-dioxide. The above electron transporters may be used singly or in combination.

Examples of the hole transporters include electron-donators, for example, an oxazole derivative, an oxadiazole derivative, an imidazole derivative, a triphenyl amine derivative, 9-(p-diethylamino styrylanthracene), 1,1-bis-(4-dibenzylaminophenyl)propane, styrylanthracene, styryl pyrazolin, a phenyl hydrazone, an α-phenylstilbene derivative, a thiazole derivative, a triazole derivative, a phenazine derivative, an acridine derivative, a benzofuran derivative, a benzimidazole derivative, and a thiophene derivative. The above hole transporters may be used singly or in combination.

The binder resin used in the charge transport layer together with the electric charge transporter may be a thermo-plastic or thermoset resin. Examples include polystyrene, a styrene-acrylonitrile co-polymer, a styrene-butadiene co-polymer, a styrene-maleic anhydride co-polymer, polyester, polyvinyl chloride, a chloroethylene-vinyl acetate co-polymer, polyvinyl acetate, polyvinylidene chloride, polyallirate, phenoxy, polycarbonate, cellulose acetate, ethyl cellulose, polyvinyl butyral, polyvinyl formal, polyvinyl toluene, acrylic, silicone, epoxy, melamine, urethane, phenol, and alkyd.

Examples of the solvent include tetrahydrofuran, dioxan, toluene, 2-butanone, monochlorbenzene, dichlorethane, and methylene chloride.

The thickness of the electric charge transport layer may be determined within a range from 15 μm to 35 μm, so that the photoreceptor 40 has a desirable property.

A common plasticizer for resins (e.g., dibutylphthalate and dioctylphthalate) may be used as the plasticizer that is added to the charge transport layer as required. The usage of the plasticizer may be 0 to 30 weight percent to the binder resin.

Examples of the leveling agent include silicone oils (e.g., dimethyl silicone oil and methyl phenyl silicone oil), and polymers and oligomers having perfluoroalkyl group as a lateral chain. The usage of the leveling agent may be 0 to 1 weight percent to the binder resin.

In an exemplary embodiment, a desirable content of the charge transporter in the photoreceptive layer is 30 weight percent or greater in the charge transport layer. When a pulsed laser light is applied to the photoreceptor 40 during a writing process, the charge on the surface of the photoreceptor 40 disappears. This is referred to as photo-induced discharge. However, it is difficult to secure sufficient time for the photo-induced discharge in high-speed electronographic methods if the content of the charge transporter in the charge transport layer is under 30 weight percent.

In an exemplary embodiment, the photoreceptor 40 may further include an under layer between the electroconductive supporter and the photoreceptive layer. The under layer may include a resin as a main component. The resin is selected in view of that the photoconductive layer may be applied to the electroconductive support by using a solvent. Therefore, the resin desirably has a higher resistance to common solvents. Examples of the resin include water-soluble resins (e.g., polyvinyl alcohol, casein, and sodium polyacrylate), alcohol fusible resins (e.g., interpolymerization nylon and methoxy methylation nylon), and cured resins that form a three-dimensional network structure (e.g., polyurethane, melamine, alkyd-melamine, and epoxy).

The under layer may include fine particles of a metal oxide to avoid moire and to reduce residual potential. Examples of the metal oxide include titanium oxide, silica, alumina, zirconia, tin oxide, and indium oxide. The under layer may be formed through a coating method using a solvent, similarly to the photoreceptive layer.

Alternatively, the under layer may be a metal oxide layer formed through a sol-gel process using a silane coupling agent, a titan coupling agent, a chrome coupling agent, etc.

Alternatively, the under layer may include an anodic oxidized Al₂O₃. Alternatively, the under layer may be formed through a vacuum film-forming method using an organic compound (e.g., poly-para-xylylene or parylene) or an inorganic compound (e.g., Sio, SnO₂, TiO₂, ITO, and CeO₂). The under layer may have a thickness within a range from 0 to 5 μm.

The relation between defective image occurrence due to the photoreceptor 40 and the voltage applied to the discharge lamp 72 was studied by using the image forming apparatus 100. The result is shown in table 1.

TABLE 1

| | Voltage (V) | | | | | | | | | |
|---|---|---|---|---|---|---|---|---|---|---|
| | 0 | 8.2 | 12.1 | 12.6 | 13.0 | 13.5 | 13.9 | 14.9 | 16.1 | 24.0 |
| Current | 0 | 0 | 0 | 0.2 | 0.5 | 0.8 | 1.1 | 1.8 | 2.6 | 8.0 |
| (mA) | | | | | | | | | | |
| Afterimage | Bad | Bad | Bad | Average | Good | Good | Good | Good | Good | Good |

In the above study, positive afterimage occurred when the discharge voltage was turned off and was under 13 V. The positive afterimage is described below. When a solid image is output in a cycle and a half-tone image is output in a following cycle, the portion of photoreceptor 40 on which the solid image is formed has a higher density in the following cycle than the density in any other portions.

In the study, the potential on the photoreceptor 40 was measured after the discharge. The result of the potential measurement is shown in Table 2.

TABLE 2

| | Voltage (V) | | | | | | | | | |
|---|---|---|---|---|---|---|---|---|---|---|
| | 0 | 8.2 | 12.1 | 12.6 | 13.0 | 13.5 | 13.9 | 14.9 | 16.1 | 24.0 |
| Current | 0 | 0 | 0 | 0.2 | 0.5 | 0.8 | 1.1 | 1.8 | 2.6 | 8.0 |
| (mA) | | | | | | | | | | |
| Potential | −485 | −485 | −485 | −300 | −225 | −170 | −95 | −75 | −70 | −70 |
| after | | | | | | | | | | |
| discharge | | | | | | | | | | |
| Discharge | Bad | Bad | Bad | Bad | Bad | Bad | Bad | Average | Good | Good |
| property | | | | | | | | | | |

As shown in tables 1 and 2, the defective images were prevented even when the voltage applied to the discharge lamp 72 was not sufficient to discharge the photoreceptor 40 after the transfer process. For example, a required voltage to prevent afterimages to a level of “average” was 12.6 V in table 1, although a required voltage to discharge the surface of the photoreceptor 40 to a level of “average” was 14.9 V in table 2.

Therefore, the amount of discharge light may be set to a minimum amount to prevent defective images during image formation (between image forming operations) and to a required amount to sufficiently discharge the photoreceptor 40 just before the photoreceptor 40 is stopped (during post image-forming processing). The optical fatigue of the photoreceptor 40 may be reduced while the defective image is prevented by setting the amount of the discharge light as above.

The required amount of light to discharge the photoreceptor 40 depends on the charge potential of the photoreceptor 40. As the charge potential of the photoreceptor 40 becomes larger, the required amount of the discharge light increases. The charge potential depends on a usage environment of the photoreceptor 40. In the case of the image forming apparatus 100 having a plurality of photoreceptors 40, the photoreceptors 40 of respective colors often have different charge potentials because the charge potential is affected by the condition of the developers of respective colors. Therefore, in an exemplary embodiment, the amount of the discharge light during the image formation and/or the amount of the discharge light during the post image-forming processing is adjustable for each color so that each of the photoreceptors 40 receives a proper amount of the discharge light.

Further, in the case of an image forming apparatus using a plurality of image-forming linear speeds, the required amount of the discharge light depends on the image-forming linear speeds. For example, different image-forming linear speeds are used for recording mediums having different thickness. The image-forming linear speed is a circumference of the photoreceptor 40 multiplied by a rotation velocity of the photoreceptor 40.

Therefore, in an exemplary embodiment, the amount of the discharge light during the image formation and/or during the post image-forming processing is changed, depending on the charge potential and/or the image-forming linear speed. This is effective to reduce the optical fatigue of the photoreceptor 40 as well as to reduce the defective image.

Next, the discharge lamp 72 is described. In an exemplary embodiment, the discharge lamp 72 is an LED (light-emitting diode) having an emission wavelength of 600 nm. FIG. 4 illustrates a relation between the voltage applied to the discharge lamp 72 and the current flowing therein.

It is known that an LED does not allow an electric current to flow therein unless a voltage of a certain amount or greater is applied thereto, due to its characteristic. Further, it is known that the amount of the discharge light applied to the photoreceptor 40 is proportional to the amount of the electric current. Therefore, the amount of the discharge light applied to the photoreceptor 40 may be controlled by controlling the voltage applied to the discharge lamp 72 (constant voltage control) or by controlling the current applied to or flowing in the discharge lamp 72 (constant current control). The amount of the discharge light may be more directly controlled by the constant current control than by the constant voltage control. In a known method, a complicated mechanism is used and a width of a slit is changed to adjust the amount of the discharge light. To the contrary, the amount of the discharge light may be easily adjusted without a complicated mechanism in a method to control the voltage or the current applied to the discharge lamp 72.

As described above, in an exemplary embodiment, the optical fatigue of a photoreceptor may be reduced to minimum by setting the amount of the discharge light to a minimum amount to prevent defective images during image formation and to a required amount to discharge the photoreceptor 40 during post image-forming processing. Further, the photoreceptor may be sufficiently discharged and optical fatigue may be reduced to minimum by adjusting the amount of the discharge light depending on charge potentials on the respective photoreceptors. Further, the photoreceptor may be sufficiently discharged and optical fatigue may be reduced to minimum by adjusting the amount of the discharge light depending on an image-forming linear speed.

Further, the optical fatigue of a plurality of photoreceptors may be reduced to minimum by setting the amount of the discharge light separately depending on respective image forming conditions.

Having now fully described exemplary embodiments of the invention, it will be apparent to one of ordinary skill in the art that many changes and modifications can be made thereto without departing from the spirit and scope of the invention as set forth therein.

What is claimed is:

1. An image forming apparatus, comprising:
an image bearer configured to bear an electrostatic latent image;
a charger configured to charge the image bearer; and
a discharger configured to discharge the image bearer with a discharge light,
wherein an amount of the discharge light during image formation is different from an amount of the discharge light during post image-formation processing.

2. The image forming apparatus according to claim 1, wherein the amount of the discharge light applied to the image bearer from the discharger is larger during the post image-forming processing than during the image formation.

3. The image forming apparatus according to claim 1, wherein at least one of the amount of the discharge light during the image formation and the amount of the discharge light during the post image-forming processing varies depending on a charge potential of the image bearer.

4. The image forming apparatus according to claim 1, wherein the image forming apparatus uses a plurality of image-forming linear speeds and at least one of the amount of the discharge light during the image formation and the amount of the discharge light during the post image-forming processing varies depending on the image-forming linear speed.

5. The image forming apparatus according to claim 1, further comprising:
a plurality of image bearers, each configured to bear an electrostatic latent image; and
a plurality of dischargers, each configured to apply a discharge light to one of the image bearers to discharge the image bearer,
wherein the amount of the discharge light is variable for each of the image bearer.

6. The image forming apparatus according to claim 1, further comprising:
an intermediate transfer member to which an image is transferred from the image bearer; and
a secondary transferer configured to transfer the image from the intermediate transfer member to a transfer medium.

7. The image forming apparatus according to claim 1, wherein the amount of the discharge light is changed by changing a voltage applied to the discharger.

8. The image forming apparatus according to claim 1, wherein the amount of the discharge light is changed by changing an electric current applied to the discharger.

9. The image forming apparatus according to claim 1, wherein the charger is provided at a position contacting or adjacent to the image bearer, and
a charge bias including a DC bias overlapped with AC bias is applied to the charger.

10. The image forming apparatus according to claim 9, wherein the charger is a roller provided at the position adjacent to the image bearer and includes:
an electroconductive supporter;
a charging member including an electroconductive resin; and
a gap holder including an insulating resin,
wherein the gap holder contacts a non-image region of the image bearer to form a gap between the charging member and the image bearer.

11. A process cartridge configured to be attachable to and detachable from the image forming apparatus of claim 1, comprising:
the image bearer; and
the discharger.
